(19) United States
(12) Patent Application Publication
(10) Pub. No.: US 2010/0219597 A1
(43) Pub. Date: Sep. 2, 2010

(54) Skateboard

(76) Inventor: Ho Seong Choi, Incheon (KR)

Correspondence Address: CHRISTOPHER PAUL MITCHELL, 888 16TH ST., NW, SUITE 800, WASHINGTON, DC, 20006, US

(21) Appl. No.: 11/992,380

(22) PCT Filed: Jun. 27, 2007
(86) PCT No.: PCT/KR2007/003109

§ 371 Date: Mar. 21, 2008

(30) Foreign Application Priority Data
Jul. 4, 2006 (KR) 10-2006-0062599
Nov. 9, 2006 (KR) 10-2006-0110678
Nov. 27, 2006 (KR) 10-2006-0117683
Jun. 8, 2007 (KR) 10-2007-0056208

(51) Int. Cl. B62M 1/00

(52) U.S. Cl. 280/87.042

(57) ABSTRACT

Provided is a skateboard. The skateboard includes front and rear boards each including a foot placing unit, a directional caster including at least two connectors respectively disposed on bottom surfaces of the front and rear boards at a predetermined distance, rotating arms rotatably coupled to the connectors respectively, and wheels respectively supported by the rotating arms and rollingly contacting the ground, and a connection unit having both ends axial-rotatably and pivotally connected to one sides of the front and rear boards.

### TECHNICAL FIELD

The present invention relates to a skateboard, and more particularly, to a skateboard for generating a propulsive force by bending and twisting a pair of front board and a rear board thereof.

### BACKGROUND ART

In general, a skateboard is a tool that a user may ride with two feet putted thereon. FIG. 1 shows a conventional skateboard divided into a front board and a rear board, which enables a user to generate a propulsive force by moving two feet in a right and left direction.

As shown in FIG. 1, the conventional skateboard 10 includes a front board 1, a rear board 2, a directional caster 3, and a connection member 4.

In the conventional skateboard 10, the directional caster 3 is disposed on the bottom of the front board 1 or the rear board 2 for enabling the front and rear boards 1, 2 to generate a propulsive force.

The connection member 4 prevents the front board 1 from being separated from the rear board 2 longer than a predetermined distance.

Since the connection member 4 is a flexible member that connects the front board 1 and the rear board 2, a user must keep a gap between the front board 1 and the rear board 2 using the strength of user's own feet when the user rides the conventional skate board. Such a structure of the conventional skateboard makes a user to be easily tired when the user rides the conventional skateboard. Therefore, it is difficult for a user to ride the conventional skateboard for a long time. Furthermore, such a structure of the conventional skateboard degrades the stability thereof when it is running.

In order to overcome the shortcomings of the conventional skateboard, a skateboard having a rod-shaped connection member was introduced. The rod-shaped connection member has one end fixed to the front board using a spherical joint and the other end inserted into a fixing unit disposed at the bottom surface of the rear board.

The conventional skateboard having the rod-shaped connection member allows a pivotal movement of the connection member because only one side of the connection member is fixed to the front board using the spherical joint. However, since the radius of the pivotal movement is short, it is difficult for a user to effectively bend and twist the front and rear boards.

### DISCLOSURE OF INVENTION

### Technical Problem

The present invention is designed in consideration of the above drawbacks, and therefore an object of the present invention to provide a skateboard having front and rear boards, which are bendably and twistably connected to each other for improving stability and effectively generating propulsive force at the same time and for enabling a user to easily turn a direction.

### Technical Solution

In accordance with one aspect of the present invention, there is provided a skateboard including: front and rear boards each including a foot placing unit; a directional caster including at least two connectors respectively disposed on bottom surfaces of the front and rear boards at a predetermined distance, rotating arms rotatably coupled to the connectors respectively, and wheels respectively supported by the rotating arms and rollingly contacting the ground; and a connection unit having both ends axial-rotatably and pivotally connected to one sides of the front and rear boards.

In accordance with another aspect of the present invention, there is also provided a skateboard including: front and rear boards each having a center formed in a concave shape to disposed a foot placing unit closer to the ground; a directional caster including at least two connectors respectively disposed on bottom surfaces of the front and rear boards at a predetermined distance, rotating arms rotatably coupled to the connectors respectively, and wheels respectively supported by the rotating arms and rollingly contacting the ground; a plate-shaped cover covering tops of the foot placing units of the front and rear boards, respectively; and a connection unit having both ends axial-rotatably and pivotally connected to one sides of the front and rear boards.

### ADVANTAGEOUS EFFECTS

A skateboard according to an embodiment of the present invention includes a connection unit that can make axial rotation and pivotal movement with respect to a fixing unit. That is, the connection unit allows a front board and a rear board of the skateboard to be bent and to be twisted. Therefore, such a structure of the skateboard according to the embodiment effectively generates propulsive force and enables a user to easily turn a direction.

Also, the skate board according to an embodiment of the present invention includes a bearing member disposed at a connection portion between the fixing unit and the connection unit, and an elastic member disposed at an outer circumference of the connection unit for enabling the connection unit to make smooth movement against the fixing unit. Therefore, a user may ride the skateboard more stably.

Furthermore, the skateboard according to the embodiment of the present invention allows a user to adjust the length of the connection unit. Therefore, a user can control a propulsive force of the skateboard according to the skill level or the physical conditions of the user.

Moreover, the skateboard according to the embodiment of the present invention includes foot placing units disposed near the ground for enabling a user to keep more stable posture. Thus, a user can stably ride the skateboard although the skateboard has larger-diameter wheels for increasing the speed thereof. In addition, the connection unit is lengthily disposed on the top surface of the front and rear boards for increasing the radius of rotation and enhancing the propulsive force.

### BRIEF DESCRIPTION OF THE DRAWINGS

FIG. 1 is a perspective view of a skateboard according to the related art;

FIG. 2 is a side view of a skateboard according to a first embodiment of the present invention;

FIG. 3 is an exploded sectional view of the part A of FIG. 2;

FIG. 4 is another exploded sectional view illustrating the part A of FIG. 2;

FIG. 5 is still another exploded sectional view depicting the part A of FIG. 2;

FIG. 6 is an enlarged view showing the part B of FIG. 5;

FIG. 7 is a perspective view of a skateboard according to a second embodiment of the present invention;

FIG. 8 is a side view of a connection status between a fixing unit and a connection unit of the skateboard shown in FIG. 7;

FIG. 9 is a perspective view of a skateboard according to a third embodiment of the present invention;

FIG. 10 is a side view of FIG. 9;

FIG. 11 is a sectional view illustrating the part C of FIG. 10;

FIG. 12 is a bottom view showing a used state of the part C of FIG. 10;

FIG. 13 is a side view depicting an elastic member of the skateboard of FIG. 10, which is disposed between front and rear fixing members;

FIG. 14 is a sectional view showing the part D of FIG. 13;

FIG. 15 is a side view of a skateboard according to a fourth embodiment of the present invention;

FIG. 16 is an exploded perspective view illustrating a fixing unit connected to a connection unit in the skateboard shown in FIG. 15;

FIG. 17 is a perspective view showing a skateboard according to a fifth embodiment of the present invention;

FIG. 18 is a side view of FIG. 17;

FIG. 19 is a sectional view depicting the part E of FIG. 18;

FIG. 20 is a perspective view illustrating a skateboard according to a sixth embodiment of the present invention;

FIG. 21 is a side view of FIG. 20; and

FIG. 22 is a perspective view showing a skateboard according to a seventh embodiment of the present invention.

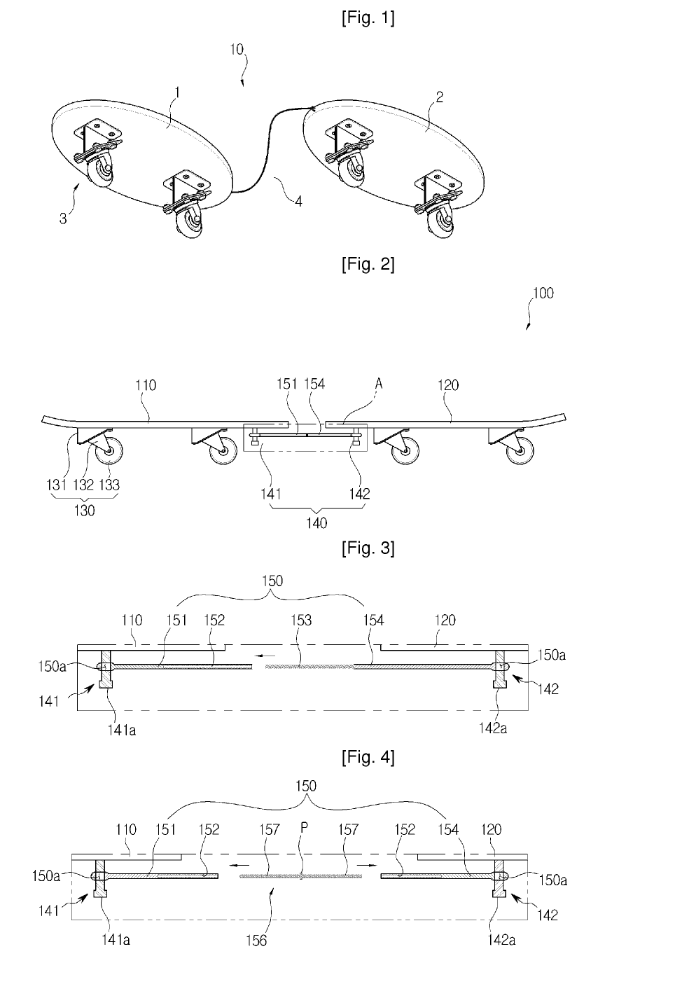

### MODE FOR THE INVENTION

Hereinafter, a skateboard according to a first embodiment of the present invention will be explained in detail with reference to the accompanying drawings.

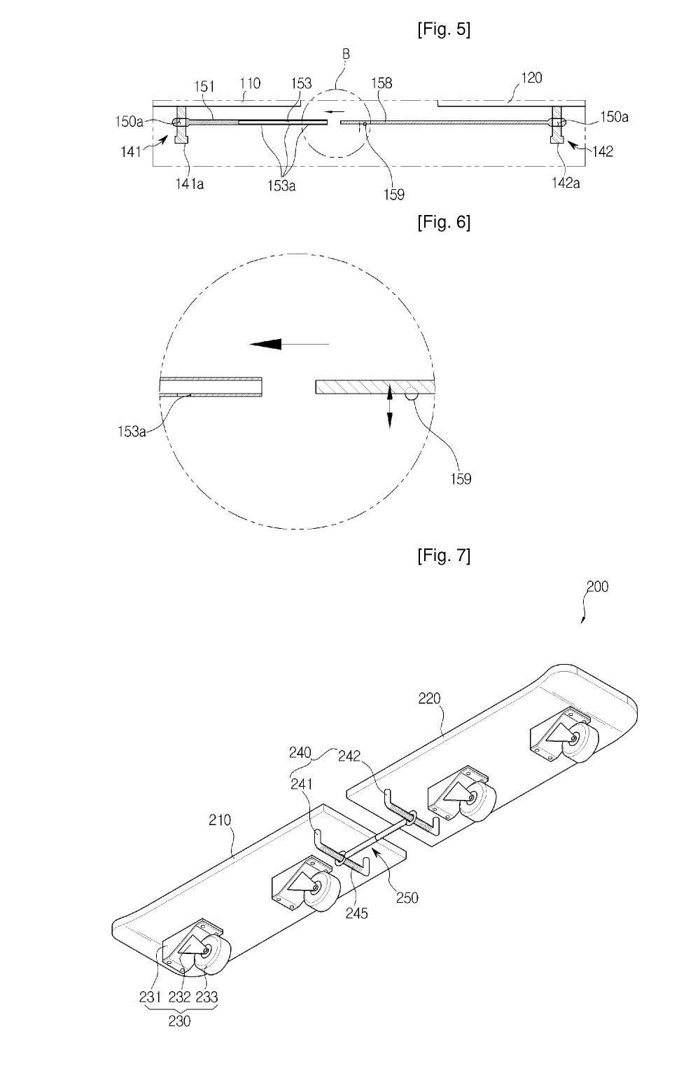

FIG. 2 is a side view of a skateboard according to a first embodiment of the present invention, FIG. 3 is an exploded sectional view of the part A of FIG. 2, FIG. 4 is another exploded sectional view of the part A of FIG. 2, FIG. 5 is still another exploded sectional view of the part A of FIG. 2, and FIG. 6 is an enlarged view of the part B of FIG. 5.

As shown in FIG. 2 and FIG. 3, the skateboard 100 according to the first embodiment of the present invention includes a front board 110, a rear board 120, a directional caster 130, a fixing unit 140 and a connection unit 150.

The front board 110 supports one of user's feet on its top surface. The front board 110 is not limited to the shape thereof shown in FIG. 2. The front board 110 may be modified in various shapes.

The rear board 120 is disposed at one side of the front board 110 to be spaced apart from the front board 110. The rear board 120 supports the other foot of the user on its top surface. The rear board 120 may also be modified in various shapes.

At least two directional casters 130 are disposed at the bottom surfaces of the front board 110 and the rear board 120, respectively. Since at least two directional casters 130 are disposed respectively at the bottom surfaces of the front board 110 and the rear board 120, the connection unit 150 does not receives an excessive force, and a user may use the skateboard 100 more stably.

Each of the directional casters 130 includes a connector 131, a rotating arm 132 and a wheel 133 for enabling the front board 110 or the rear board 120 to run.

The connector 131 is disposed at the bottom surface of the front board 110 and the rear board 120 for connecting the rotating arm 132 and the wheel 133 to the front board 110 or the rear board 120 at predetermined slopes.

Also, the rotating arm 132 is rotatably connected to the connector 131. Therefore, a user can conveniently change the direction of the front board 110 or the rear board 120 without limitation.

The fixing unit 140 includes front and rear rod-shaped fixing members 141, 142 disposed at the bottom surfaces of the front and rear boards 110, 120. The front and rear members 141, 142 include hooking portions 141a, 142a at one side thereof, respectively. The hooking portions 141a and 142a sustain the fixing unit 140 to be inserted into one side of the connection unit 150.

The connection unit 150 is length-adjustably disposed. Thus, a user can adjust the running power of the skateboard 100 according to a skill level or physical conditions of the user by adjusting the length thereof. In more detail, a user can control the skateboard 100 to bend and to twist greater for generating more running power by extending the length of the connection unit 150 longer. On the contrary, a user can reduce the running power by shortening the length of the connection unit 150.

In order to adjust the length of the connection unit 150 as shown in FIG. 3, the connection unit 150 includes a first connection member 151 and a second connection member 154. A female screw 152 is formed in a length direction on one end of the first connection member 151 adjacent to the second connection member 154, and a male screw 155 is formed on the second connection member 154 corresponding to the female screw 152 in order to screw-connect the first connection member 151 and the second connection member 154.

Such configuration of the connection unit 150 is just a first embodiment of the present invention. The connection unit 150 may be modified to any configuration that allows the length of the connection unit 150 to be adjustable.

For example, the connection unit 150 may include a first connection member 151, a second connection member 154 and an insert member 156 as shown in FIG. 4. Female screws 152 are formed on one ends of the first and second connection members 151 and 154 respectively, and male screws 157 are formed on both ends of a protrusion P at the center of the insert member 156. Both ends of the protrusion P are screw-connected to the female screws 152 of the first and second connection members 151 and 154. That is, it is possible to control the length of the connection unit 150 according to the degree of inserting the male screw 157 into the female screw 152 because the male screws 157 of the insert member 156 are respectively inserted into and screwed with the female screws 152 of the first and second connection members 151 and 154.

For another example, the first connection member 151 has a concave groove 153 formed in its length direction and a plurality of perforations 153a are formed in the concave groove 153 in a radial direction as shown in FIGS. 5 and 6. Therefore, an elastic ball 159 of the second connection member 158 is selectively inserted into the perforations 153a. That is, when the second connection member 158 is inserted into the concave groove 153 of the first connection member 151, the elastic ball 159 is inserted with the first connection member 151 elastically. When the elastic ball 159 reaches the perforation 153a, it elastically ascends. As a result, it is caught by the perforation 153a, and the second connection member 158 is coupled with the first connection member 151.

In addition, the connection unit 150 has holes 150a respectively formed in both ends thereof, and one side of each of the first and rear fixing members 141, 142 is respectively inserted into the formed holes 150a.

The hole 150a of the connection unit 150 has a size greater than the thickness of the front and rear fixing members 141, 142. Accordingly, the connection unit 150 may be axial-rotatably and pivotally connected to the front and rear fixing members 141, 142 with respect to the front and rear fixing members 141, 142.

Since the both ends of the connection unit 150 are axial-rotatably and pivotally connected to the fixing unit 140, it is possible to maximize the bending and twisting movement of the front and rear boards 110 and 120. Accordingly, the skateboard 100 of the present invention can easily change its running direction and maximize its propulsive force.

In addition, the skateboard 100 of the first embodiment includes bearings (not shown) in the holes 150a of the connection unit 150 and between the front and rear fixing members 141, 142. Thus, the connection unit 150 may stably pivots and axially rotates with respect to the front and rear fixing members 141, 142, thereby enhancing stability while the skateboard 100 is running. Accordingly, the skateboard 100 of the present invention has advantages of maximizing a propulsive force and enhancing stability.

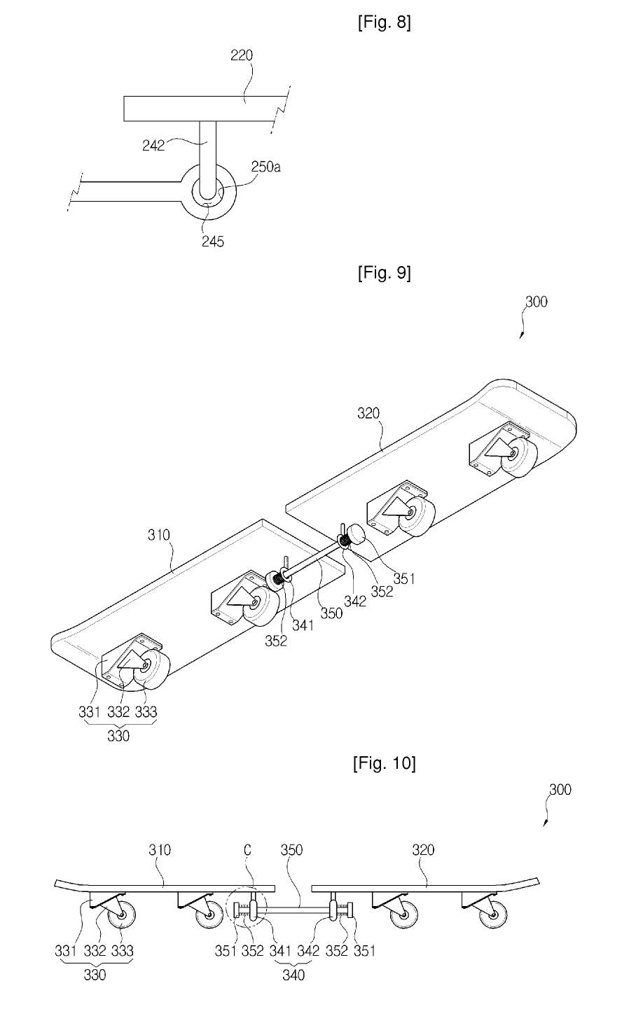

Hereinafter, a skateboard 200 according to a second embodiment of the present invention will be explained with reference to FIGS. 7 and 8.

FIG. 7 is a perspective view of a skateboard according to the second embodiment of the present invention, and FIG. 8 is a side view of a fixing unit connected to a connection unit in the skateboard shown in FIG. 7.

As shown in FIGS. 7 and 8, the skateboard 200 of the second embodiment includes a front board 210, a rear board 220, a directional caster 230, a fixing unit 240, and a connection unit 250.

The front board 210, the rear board 220 and the directional caster 230 of the skateboard 200 of the second embodiment are identical to the front board 110, the rear board 120 and the directional caster 130 of the skateboard 100 of the first embodiment. Therefore, the detailed description thereof is omitted.

The fixing unit 240 includes a front fixing member 241 disposed at a bottom surface of the front board 210, and a rear fixing member 242 disposed at a bottom surface of the rear board 220. The front and rear fixing members 241 and 242 are formed to have a center spaced apart from the front and rear boards 210 and 220 at a predetermined distance in parallel with the ground. The front and rear fixing members 241 and 242 have a bent rod shape to have both ends connected to the front and rear boards 210, 220.

Accordingly, the centers of the front and rear fixing members 241, 242 are respectively inserted into holes 250a formed in both ends of the connection unit 250, so the front and rear fixing members 241, 242 are connected to the connection unit 250.

Here, a vertical section of the center of the front and rear fixing members 241, 242 has a length smaller to a diameter of the holes 250a formed in the connection unit 250 for axial-rotatably and pivotally connecting the connection unit 250 the front and rear fixing members 241 and 242. Since both ends of the connection unit 250 are axial-rotatably and pivotally connected to the front and rear fixing members 241, 242, the front and rear boards 210, 220 may be bent and twisted more easily, and accordingly the skateboard 200 may maximize a propulsive force in running and facilitate easier change of direction.

Elastic members 245 are respectively disposed at predetermined positions of the front and rear fixing members 241, 242 corresponding to the insides of the holes 250a of the connection unit 250. The elastic members 245 are formed to receive the centers of the front and rear fixing members 241, 242. The elastic members 245 between the front and rear fixing members 241, 242 and the connection unit 250 enables the connection unit 250 to smoothly axial-rotate and pivot with respect to the front and rear fixing members 241 and 242. In the present embodiment, the elastic member 245 may be made of rubber material. However, the present invention is not limited thereto. The elastic member may also be made of various materials with elasticity.

Also, the front and rear fixing members 241 and 242 have the elastic members 245 on their outer circumference, respectively. The elastic members 245 prevent the elastic force of the elastic members 245 from making abrupt pivoting movement of the connection unit 250 while the skateboard is running. Therefore, a user can ride the skateboard 200 stably and safely.

Meanwhile, the connection unit 250 of the second embodiment may be modified in any configurations that allow the length thereof to be adjustable, for example, various modifications explained in the first embodiment (see FIGS. 3 to 6).

Hereinafter, a skateboard 300 according to a third embodiment of the present invention will be explained with reference to FIG. 9 to FIG. 14.

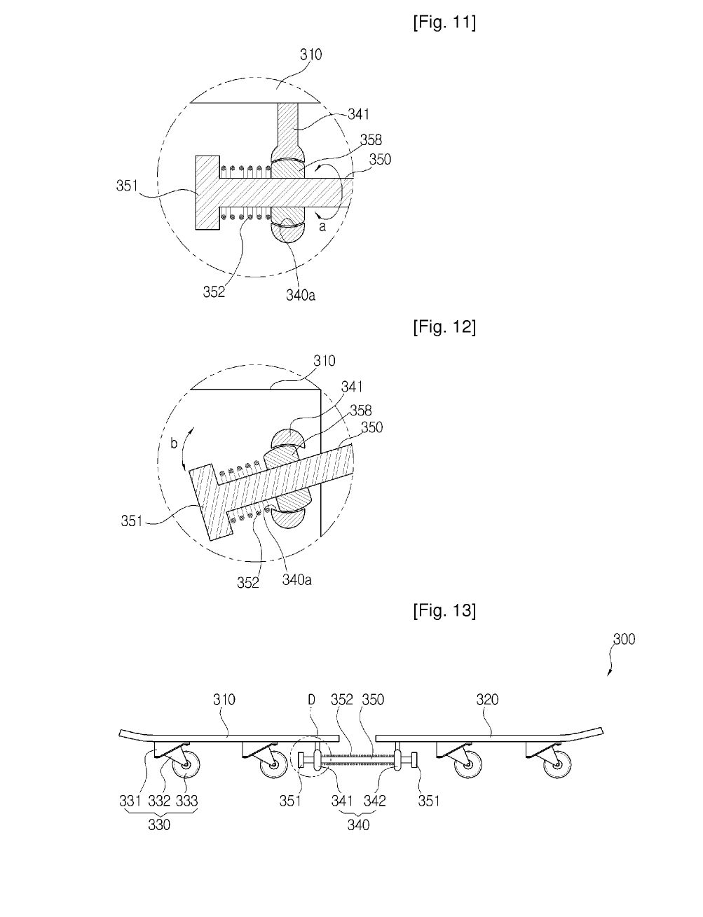

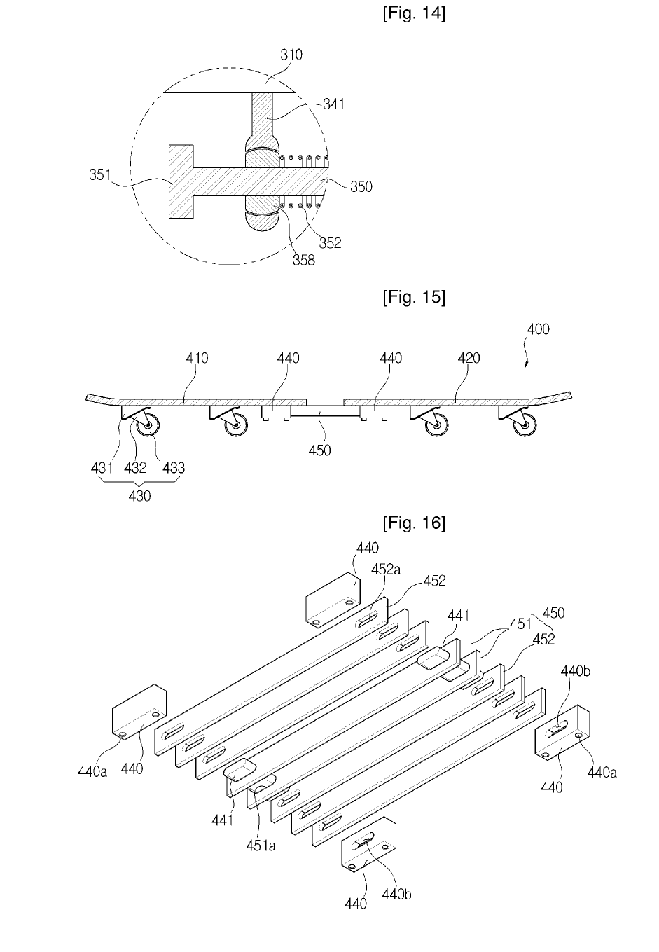

FIG. 9 is a perspective view of a skateboard according to the third embodiment of the present invention, FIG. 10 is a side view of FIG. 9, FIG. 11 is a sectional view of the part C of FIG. 10, FIG. 12 is a bottom view showing a used state of the part C of FIG. 10, FIG. 13 is a side view showing an elastic member of the skateboard of FIG. 10, which is installed between front and rear fixing members, and FIG. 14 is a sectional view showing the part D of FIG. 13.

As shown in FIGS. 9 to 14, the skateboard 300 of the third embodiment includes a front board 310, a rear board 320, a directional caster 330, a fixing unit 340 and a connection unit 350.

The front board 310, the rear board 320 and the directional caster 330 of the skateboard 300 of the third embodiment are identical to the front board 110, the rear board 120 and the directional caster 130 of the skateboard 100 of the first embodiment. Therefore, the detailed description thereof is omitted.

Referring to FIG. 9 to FIG. 12, the fixing unit 340 includes front and rear fixing members 341 and 342 on bottom surfaces of the front and rear boards 310 and 320. Here, each of the front and rear fixing members 341 and 342 includes one side having a hollow 340a. The connection unit 350 is inserted and fixed in the hollows 340a.

Also, bearings 358 are disposed in the hollows 340a of the front and rear fixing members 341 and 342, and the connection unit 350 is inserted into the bearings 358. Since the bearings 358 are disposed between the fixing unit 340 and the connection unit 350, the connection unit 350 may make more smooth axial-rotation motion and pivoting motion with respect to the fixing unit 340 while the skateboard 300 is running. Accordingly, a user may ride the skateboard 300 more stably.

Here, the axial-rotation motion of the connection unit 350 is indicated as the direction “a” in FIG. 11, and the pivoting movement is indicated as the direction “b” in FIG. 12.

The connection unit 350 includes hooking portions 350 formed at both ends thereof. The hooking portions 351 prevent the connection unit 350 inserted into the front and rear fixing members 341 and 342 from being separated therefrom.

In addition, a vertical section of the connection unit 350 has a length shorter than diameter of the hollows 340a formed in the front and rear fixing members 341 and 342 for axial-rotatably and pivotally connecting the connection unit 350 to the front and rear fixing members 341 and 342.

The connection unit 350 may maximize the bending motion and the twisting motion of the front and rear boards 310 and 320 because the both ends of the connection unit 350 are connected to be axially rotatable and pivotal with respect to the fixing unit 340. Accordingly, the skateboard 300 of the present embodiment may easily change its running direction and maximize a propulsive force.

In addition, the skateboard 300 according to the present embodiment further includes an elastic member 352 on an outer circumference of the connection unit 350. The elastic member 352 enables the connection unit 350 to smoothly axial-rotate and pivot. The elastic member 352 also further improves the stability of the skateboard 300. The elastic member 352 may be installed respectively between the front and rear fixing members 341 and 342 and the hooking portion 351 of the connection unit 350 as shown in FIG. 10 to FIG. 12. A single elastic member 352 may be disposed between the front fixing member 341 and the rear fixing member 342 as shown in FIG. 13 and FIG. 14.

Meanwhile, the connection unit 350 of the third embodiment may be modified into any configurations that allow the length thereof to be adjusted, for example various modifications mentioned in the first embodiment (see FIG. 3 to FIG. 6).

Hereinafter, a skateboard 400 according to a fourth embodiment of the present invention will be explained with reference to FIGS. 15 and 16.

FIG. 15 is a side view showing a skateboard according to the fourth embodiment of the present invention, and FIG. 16 is an exploded perspective view showing a connection state of a fixing unit and a connection unit of the skateboard shown in FIG. 15.

As shown in FIG. 15 and FIG. 16, the skateboard 400 of the fourth embodiment includes a front board 410, a rear board 420, a directional caster 430, a fixing unit 440, and a connection unit 450.

The front board 410, the rear board 420 and the directional caster 430 of the skateboard 400 of the fourth embodiment are identical to the front board 110, the rear board 120 and the directional caster 130 of the skateboard 100 of the first embodiment. The detailed description thereof is omitted.

As shown in FIG. 15 and FIG. 16, the fixing unit 440 includes bolt coupling holes 440a formed in its bottom surface in order to connect the top surface of the fixing unit 440 to the bottom surfaces of the front and rear boards 410 and 420. The bolt coupling holes 440a are respectively disposed at the front and rear boards 410 and 420 in pairs.

Also, it is preferable that a pair of the fixing units 440 has a pin coupling hole 440b in one of sides facing each other in order to be connected with corresponding pin 441 on the bottom surface of the front and rear boards 410 and 420.

Since it is preferable to form the connection unit 450 in a form of a plurality of leaf springs, the connection unit 450 includes a pair of first connection plates 451 having two holes 451a with a size suitable for the pins 441, and a plurality of second connection plates 452 having two holes 452a greater than the pins 441 and inserted into the pins 441 protruded on both sides of the first connection plates 451.

In this configuration of the skateboard 400 of the fourth embodiment, the pin 441 is inserted into the holes 451a of the pair of first connection plates 451, and the plurality of second connection plates 452 are inserted into both sides of the pin 441. Also, both ends of the pin 441 protruded on both sides of the second connection plates 452 are respectively coupled in the pin coupling holes 440b of the fixing unit 440, and then the connection unit 450 is completely assembled.

Thus, the front and rear boards 410, 420 of the skateboard 400 of this embodiment are connected by means of the connection unit 450 that allows axial rotation and pivoting, so the front and rear boards 410, 420 may be twisted or bend in opposite directions.

That is to say, in case the front board 410 of the skateboard 400 of this embodiment is pivoted into one direction and then intends to change its direction in another side, the front board 410 is elastically restored due to the connection unit 450, so the front board 410 may be more easily pivot, advantageously.

In addition, the skateboard 400 of this embodiment may easily change its direction with a small force if the front board 410 is pivoted with being twisted upward in a running direction.

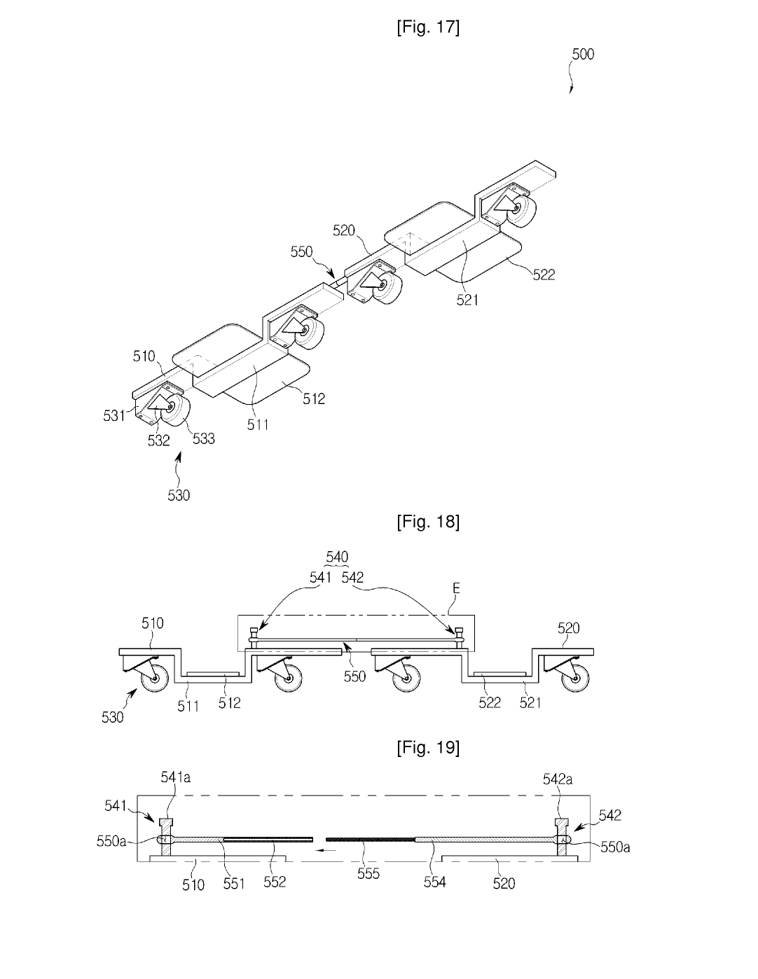

Hereinafter, a skateboard 500 according to a fifth embodiment of the present invention will be explained with reference to FIGS. 17 to 19.

FIG. 17 is a perspective view of a skateboard according to the fifth embodiment of the present invention, and FIG. 18 is a side view of FIG. 17, and FIG. 19 is a sectional view showing the part E of FIG. 18.

As shown in FIGS. 17 to 19, the skateboard 500 of the fifth embodiment includes a front board 510, a rear board 520, a directional caster 530, a fixing unit 540, and a connection unit 550.

The directional caster 530 of the skateboard 500 of the fifth embodiment is identical to the directional caster 130 of the skateboard 100 of the first embodiment. The detailed descriptions thereof are omitted.

The front board 510 includes a foot placing unit 511 having one side concave toward the ground and a rectangular footstep 512 on the foot placing unit 511 for stably supporting a foot of a user.

Here, the footstep 512 preferably has s height higher than a center of a wheel 533 and lower than the height of the front board 510. Since the concave foot placing unit 511 is disposed at one side of the front board 510 as mentioned above, a user may ride the skateboard 500 with more stable posture sustained.

The rear board 520 is disposed at one side of the front board 510 at a predetermined distance therefrom. The rear board 520 supports the other foot of the user on its top surface. The rear board 520 also includes a foot placing unit 521 and a footstep 522 with the same shape as the front board 510.

The fixing unit 540 is similar to that of the first embodiment shown in FIG. 2. However, in the fifth embodiment, the fixing unit 540 is disposed on top surfaces of the front and rear boards 510 and 520.

The connection unit 550 is also similar to that of the first embodiment shown in FIG. 3. That is, the connection unit 550 is length-adjustably disposed for allowing a user to control a running power of the skateboard 500 according to the skill level or physical conditions of the user. A user can control the skateboard 500 to bend and to twist greater for generating more running power by extending the length of the connection unit 550 longer. On the contrary, a user can reduce the running power by shortening the length of the connection unit 550.

In this aspect, according to the fifth embodiment of the present invention, the connection unit 550 is arranged on the top surfaces of the front and rear boards 510 and 520. Such a configuration allows the connection unit 550 to be extended longer.

Referring to FIG. 18, the connection unit 550 is arranged on the top surfaces of the directional casters 530 adjacent to each other between the front and rear boards 510 and 520. Therefore, it is possible to make the connection unit 550 longer and increase a running power of the skateboard 500 without any limitations on installation of the directional casters 530.

Also, as shown in FIG. 19, the connection unit 550 has holes 550a formed at both ends thereof, and one sides of front and rear fixing members 541, 542 are inserted into the holes 550a, respectively.

The hole 550a of the connection unit 550 is greater than thickness of the front and rear fixing members 541 and 542. Accordingly, the connection unit 550 may be axial-rotatably and pivotally connected to the front and rear fixing members 541 and 542.

This connection unit 550 may maximize bending motion and twisting motions of the front board 510 and the rear board 520 because both ends of the connection unit 550 are axial-rotatably and pivotally connected to the fixing unit 540. Accordingly, the skateboard 500 of the present embodiment may easily change its running direction and maximize a propulsive force.

In addition, the skateboard 500 according to the fifth embodiment includes bearings (not shown) in the holes 550a of the connection unit 550 and between the front and rear fixing members 541 and 542 for enabling the connection unit 550 to smoothly pivot and axial-rotate more stably with respect to the front and rear fixing members 541 and 542. Therefore, the stability thereof becomes enhanced while the skateboard 500 is running. Accordingly, the skateboard 500 of the present embodiment may maximize a propulsive force and also maximize stability, advantageously.

The shape of the fixing unit 540 according to the present invention is not limited to the shape shown in the fifth embodiment. It is obvious to those skilled in the art that the fixing unit 540 may have configuration shown in the second embodiment (see FIG. 7), the third embodiment (see FIG. 9) and the fourth embodiment (see FIG. 15).

Also, the connection unit 550 may be modified into any configurations that allow the length thereof to be adjusted, for example various modifications shown in the first embodiment (see FIG. 4 to FIG. 6).

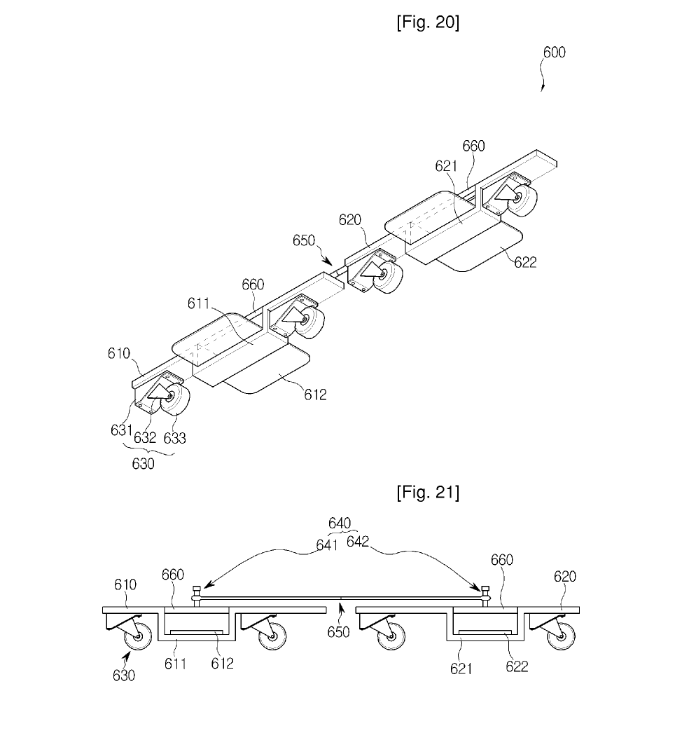

Hereinafter, a skateboard 600 according to a sixth embodiment of the present invention will be explained with reference to FIG. 20 and FIG. 21.

FIG. 20 is a perspective view of a skateboard according to a sixth embodiment of the present invention, and FIG. 21 is a side view of FIG. 20.

As shown in FIG. 20 and FIG. 21, the skateboard 600 of the sixth embodiment includes a front board 610, a rear board 620, a directional caster 630, a fixing unit 640, a connection unit 650, and a cover 660.

The front board 610, the rear board 620, the directional caster 630, the fixing unit 640 and the connection unit 650 of the skateboard 600 of the sixth embodiment are identical to the front board 510, the rear board 520, the directional caster 530, the fixing unit 540 and the connection unit 550 of the skateboard 500 of the fifth embodiment. Therefore, the detailed description thereof is omitted.

The skateboard 600 of the present embodiment includes the cover 600 to cover top sides of foot placing units 611 and 612 of the front and rear boards 610, 620. Thus, the fixing unit 640 may be disposed on the top surface of the cover 660, and the connection unit 650 may be configured further longer.

As mentioned above, the skateboard 600 according to the sixth embodiment can make further greater twisting motions and bending motions because the length of the connection unit 650 is further longer than other embodiments. Therefore, a running power of the skateboard 600 may be more improved.

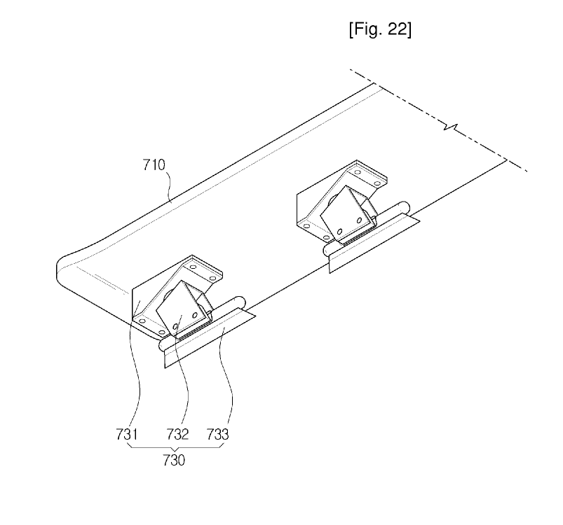

Meanwhile, the front and rear boards may be arranged in parallel with each other by rotating the front and rear boards at 90 with the front and rear fixing members as a reference in the skateboard according to the first and sixth embodiments. Therefore, a user can conveniently carry the skateboard. In a seventh embodiment, the wheels of the first to sixth embodiments may be replaced with blades 733 as shown in FIG. 22.

While the present invention has been described with respect to certain preferred embodiments, it will be apparent to those skilled in the art that various changes and modifications may be made without departing from the scope of the invention as defined in the following claims.

1. A skateboard comprising:
front and rear boards each including a foot placing unit;
a directional caster including at least two connectors respectively disposed on bottom surfaces of the front and rear boards at a predetermined distance, rotating arms rotatably coupled to the connectors respectively, and wheels respectively supported by the rotating arms and rollingly contacting the ground; and
a connection unit having both ends axial-rotatably and pivotally connected to one sides of the front and rear boards.

2. The skateboard of claim 1,
wherein each of the front and rear boards has a center formed in a concave shape to dispose the foot placing units closer to the ground.

3. The skateboard of claim 1,
wherein both ends of the connection unit are installed at the bottom surfaces of the front and rear boards.

4. The skateboard of claim 1,
wherein the connection unit includes both ends respectively installed on top surfaces of the front and rear boards, in which one end is disposed in front of a center of a rear wheel of the front board and the other end is disposed behind a center of a front connector of the rear board.

5. The skateboard of claim 1,
further comprising front and rear rod-shaped fixing members disposed on one side of the front board and the rear board respectively,
wherein holes are formed in both ends of the connection unit so as to insert the front and rear fixing members into the holes.

6. The skateboard of claim 5,
further comprising ring-shaped bearings rotatably formed in the holes of the connection unit,
wherein one sides of the front and rear fixing members are inserted into the bearings.

7. The skateboard of claim 1,
further comprising front and rear rod-shaped fixing members disposed on one sides of the front and rear boards and having hollows in one sides thereof,
wherein both ends of the connection unit are inserted into the hollows and connected to the front and rear fixing members.

8. The skateboard of claim 7,
further comprising ring-shaped bearings rotatably disposed in the hollows of the front and rear fixing members,
wherein both ends of the connection unit are inserted into the bearings, respectively.

9. The skateboard of claim 7,
further comprising elastic members disposed at predetermined positions of the connection unit corresponding to inner sides of the hollows of the front and rear fixing members.

10. The skateboard of claim 1,
wherein the connection unit is at least one leaf spring arranged along a width direction of the front and rear boards.

11. The skateboard of claim 1,
wherein the connection unit includes a first connection member having a female screw in a length direction thereof, and a second connection member having a male screw corresponding to the female screw, and the female screw and the male screw are screw-connected to control a length of the connection unit.

12. The skateboard of claim 1,
wherein the connection unit includes a first connection member having a concave groove in a length direction thereof and a plurality of perforations formed in a radial direction from the concave groove, and a second connection member having an elastic ball installed on an outer side thereof to be selectively inserted into the perforations in order to change the length of the connection unit.

13. A skateboard comprising:
front and rear boards each having a center formed in a concave shape to disposed a foot placing unit closer to the ground;
a directional caster including at least two connectors respectively disposed on bottom surfaces of the front and rear boards at a predetermined distance, rotating arms rotatably coupled to the connectors respectively, and wheels respectively supported by the rotating arms and rollingly contacting the ground;
a plate-shaped cover covering tops of the foot placing units of the front and rear boards, respectively; and
a connection unit having both ends axial-rotatably and pivotally connected to one sides of the front and rear boards.

14. The skateboard of claim 13,
further comprising front and rear rod-shaped fixing members disposed on the top surface of the cover of the front and rear boards,
wherein holes are formed in both ends of the connection unit to insert the front and rear fixing members in the holes and connected to the front and rear boards.

15. The skateboard of claim 14,
further comprising ring-shaped bearings rotatably formed in the holes of the connection unit,
wherein one sides of the front and rear fixing members are inserted into the bearings, respectively.

16. The skateboard of claim 13,
further comprising front and rear rod-shaped fixing members disposed on the top surface of the cover of the front and rear boards and having hollows formed in one sides thereof,
wherein both ends of the connection unit are inserted in the hollows.

17. The skateboard of claim 16,
further comprising ring-shaped bearings rotatably formed in the hollows of the front and rear fixing members,
wherein both ends of the connection unit are inserted into the bearings, respectively.

18. The skateboard of claim 16,
further comprising elastic members disposed at predetermined positions of the connection unit corresponding to inner sides of the hollows of the front and rear fixing members.

19. The skateboard of claim 13,
wherein the connection unit is at least one leaf spring arranged along a width direction of the front and rear boards.

20. The skateboard of claim 13,
wherein the connection unit includes a first connection member having a female screw formed in a length direction thereof, and a second connection member having a male screw formed corresponding to the female screw, and the female screw and the mail screw are screw-connected to control a length of the connection unit.

21. The skateboard of claim 13,
wherein the connection unit includes a first connection member having a concave groove formed in a length direction and a plurality of perforations formed in a radial direction of the concave groove, and a second connection member having an elastic ball installed on an outer surface for selectively inserting the elastic ball into the perforations in order to adjust the length of the connection unit.
